(19) United States
(12) Patent Application Publication
(10) Pub. No.: US 2009/0125445 A1
(43) Pub. Date: May 14, 2009

(54) System and method for capturing and certifying digital content pedigree

(75) Inventors: Kianoosh Mousavi, Ottawa (CA); Mahshad Koohgoli, Kanata (CA); Dhananjay Godse, Kanata (CA)

Correspondence Address: FREEDMAN & ASSOCIATES, 117 CENTREPOINTE DRIVE, SUITE 350, NEPEAN, ONTARIO, K2G 5X3, CA

(73) Assignee: Protecode Incorporated, Ottawa (CA)

(21) Appl. No.: 12/292,180

(22) Filed: Nov. 13, 2008

Related U.S. Application Data
(60) Provisional application No. 60/996,330, filed on Nov. 13, 2007.

(51) Int. Cl. H04L 9/00

(52) U.S. Cl. 705/59

(57) ABSTRACT

A method of automatically tracking the introduction of external digital content into digital content under development is provided. First digital content of a digital content developer is provided. Into the first digital content is inserted from a system external to systems of the digital content developer external digital content of a party other than the digital content developer. Introduction of the external digital content into the first digital content is automatically detected and data relating to a source of the external digital content or to licensing information relating to the external digital content is stored.

### FIELD OF THE INVENTION

The invention relates generally to digital data and more particularly to logging of digital content and auditing of digital content.

### BACKGROUND OF THE INVENTION

Digital content has been developed for as long as computers have been around. It exists in the form of computer programs, text documents, digital images, digital video, digital audio, software components, and blocks of computer code. Digital content producers integrate, compile and distribute digital content production to end-users. Examples of such producers include software vendors, web site designers, and audiovisual content producers. During recent years, organizations producing digital content have chosen to leverage externally developed content to gain efficiency in research and development. As a result, some organizations have chosen to develop digital content components for distribution not to end-users but to other digital content producers. For example, some companies sell digital photographs to web-site designers/producers for use in their web sites. Another class of content producer has emerged that has chosen to produce digital content or digital content components and then distribute them for free or with liberal licenses. A subset of these free content developers has chosen to distribute their content freely, but licensed in a way that requires content producers using the free content, either directly or to produce derivative works, to release their work under the same terms. Another trend in content development is the advent and increasing use of the Internet and the world-wide web.

Through the Internet, finding digital content has become easier and faster. To the extent that it is often expedient for digital content developers and their companies to acquire digital content or digital content components from third parties, it has become acceptable to do so for producing a derivative work, rather than producing all digital content internally. Alternatively developers are increasingly merging externally sourced digital content, or digital content components, and embedding them within their own digital content. For example, a developer generating software for an MP3 music player might download and embed search programming code, allowing the user to easily search for the song they want, or an enhanced display driver produced by another developer already using the same LCD display.

Whilst the increased breadth and speed of access globally to digital content has significantly eased the digital content development process, commercial enterprises now face a problem relating to intellectual property and licensing. An ability to establish the intellectual property rights of digital content increases in complexity as developers select and embed more content from many different sources into the digital content of a commercial enterprise. In some instances, with multiple development teams globally distributed to provide 24 hour code development or addressing multiple elements of the digital content, managing the intellectual property rights thereof becomes nearly unimaginable.

Knowing these intellectual property rights is crucial when establishing the valuation of businesses that derive revenue from generating and distributing original digital content, such as software companies, or companies that use digital content to derive revenue or cut costs, such as television broadcasters. When a business is being audited and evaluated, accurate records detailing all external digital content in the digital content systems is requested. These records include copyright ownership details, license agreements, and other terms and conditions. Given that it only takes seconds to copy significant amounts of external digital content into the digital content of a commercial enterprise, monitoring and reporting of these property rights is difficult.

For a digital content provider a typical high-level process for documenting external content is as follows:
Go through the digital content to identify and document each piece of known external digital content;
For each identified piece try to determine a source and, when a source is likely to be correct annotate the content with copyright owner, license, author(s), etc;
Compare all of your content with publicly comparable content, and if there is a match annotate the content with copyright owner, license, author(s);
For the remaining external content still not annotated, annotate them manually to the best of your ability with the copyright owner, license, author(s), etc.

Intellectual property lawyers and software experts are often brought into the digital content developer business to drive this process; key content developers and project leaders spend much time compiling these lists and reports. In reality this process is often prohibitively expensive because it requires manual labor and guesswork by highly qualified and expensive intellectual property lawyers and content developers. It is also error-prone, and subject to abuse by developers intent on hiding the source of their specific portions of the overall code forming the digital content offered by their employer or contract provider.

It would therefore be beneficial to overcome the limitations of the prior art.

### SUMMARY OF THE INVENTION

In accordance with an embodiment of the invention there is provided a method comprising: providing first digital content of a digital content developer; retrieving from a system external to systems of the digital content developer external digital content of a party other than the digital content developer; inserting the external digital content within the first digital content; automatically detecting introduction of the external digital content into the first digital content; and, storing external to the first digital content, data relating to a source of the external digital content.

In accordance with an embodiment the data relating to a source of the first digital content comprises data relating to licensing of the external digital content.

In accordance with an embodiment the data relating to a source of the first digital content comprises pointer data indicative of a location external to systems of the digital content developer having data stored therein data relating to licensing of the external digital content.

In accordance with an embodiment the pointer data comprises an indication of a record within a digital signature database comprising data relating to licensing and comparable content.

In accordance with an embodiment the comparable content comprises digitally signed digital content.

In accordance with an embodiment the record comprises an unalterable portion and an alterable portion, the unalterable portion comprising data relating to the digital content and the alterable portion comprising data relating to licensing thereof.

In accordance with an embodiment the data relating to licensing thereof comprises an indication of at least an owner of intellectual property within the digital content.

In accordance with an embodiment the data relating to the digital content comprises a digital signature of at least a portion of the digital content.

In accordance with an embodiment the data relating to the digital content further comprises at least one of the following: a name of a license owner, a digital signature signed by the license owner, a name of an author of the digital content, a source of the digital content, and terms for a license of the digital content.

In accordance with an embodiment of the invention the method further comprises applying at least a policy to the inserted digital content to one of allow its insertion and prevent its insertion based on the at least a policy relating to licensing of external digital content.

In accordance with an embodiment of the invention there is provided a method comprising: providing first digital content of a digital content developer; retrieving from a system external to systems of the digital content developer external digital content of a party other than the digital content developer; inserting the external digital content within the first digital content; automatically detecting introduction of the external digital content into the first digital content; and, storing within the first digital content, data relating to licensing of the external digital content.

In accordance with an embodiment the data relating to licensing comprises pointer data indicative of a location external to systems of the digital content developer having data stored therein data relating to licensing of the external digital content.

In accordance with an embodiment the pointer data comprises an indication of a record within a digital signature database comprising data relating to licensing and comparable content.

In accordance with an embodiment the comparable content comprises digitally signed digital content.

In accordance with an embodiment the record comprises an unalterable portion and an alterable portion, the unalterable portion comprising data relating to the digital content and the alterable portion comprising data relating to licensing thereof.

In accordance with an embodiment the data relating to licensing thereof comprises an indication of at least an owner of intellectual property within the digital content.

In accordance with an embodiment the data relating to the digital content comprises a digital signature of at least a portion of the digital content.

In accordance with an embodiment the data relating to the digital content further comprises at least one of the following: a name of a license owner, a digital signature signed by the license owner, a name of an author of the digital content, a source of the digital content, and terms for a license of the digital content.

In accordance with an embodiment the method comprises applying at least a policy to the inserted digital content to one of allow its insertion and prevent its insertion based on the at least a policy relating to licensing of external digital content.

In accordance with an embodiment of the invention there is provided a method comprising: providing associated with a digital content but stored separate therefrom a digital pedigree log record comprising a first predetermined portion comprising an unalterable invariant information element and a second predetermined portion comprising an alterable variant information element variable at any time.

In accordance with an embodiment the invariant information element is selected from the group comprising a digital signature of the digital content and a time signature for when the digital pedigree log record was created.

In accordance with an embodiment the variant information element is selected from the group comprising an author, an identity of a copyright holder of external content imported into the digital content, an aspect of a license associated with the external content and an aspect of another digital pedigree log record, and a reference identity of another digital pedigree log record.

In accordance with an embodiment the method comprises generating a digital signature relating to the digital pedigree log record, the digital signature being generated in dependence upon at least the invariant information element and the variant information element.

In accordance with an embodiment the method comprises publishing the digital signature to a computer system publicly accessible via a network.

In accordance with an embodiment of the invention there is provided a method comprising: generating a first pedigree log record signature from a first digital pedigree log record, the first digital pedigree log record comprising at least an information element relating to a digital content, the information element being at least one of an invariant information element and a variant information element; storing the first pedigree log record signature as a variant information element of the first digital pedigree log record; securely uploading at least one of the first digital pedigree log record and first pedigree log record signature to a secure server; and verifying the authenticity of the first digital pedigree log record with a trusted third party.

In accordance with an embodiment the method comprises generating a second pedigree log record signature for the first digital pedigree log record upon detecting an event; comparing it to the first pedigree log record signature; and determining an outcome of the comparison, the comparison being stored within a digital memory.

In accordance with an embodiment the second pedigree log record signature is different from the first pedigree log record signature if a variant information element is different and is not different from the first pedigree log record signature if each variant information element is same.

In accordance with an embodiment the outcome of the comparison is based on a determination of modification of the digital content.

In accordance with an embodiment the outcome of the comparison is dependent upon determining an origin of modified content is at least one of public domain external content, external content having a known associated license, and external content without a known associated license.

In accordance with an embodiment the method comprises automatically at least one of cross-referencing and annotating modified content with information from publicly comparable matching digital content.

In accordance with an embodiment the method comprises automatically at least one of cross-referencing and annotating comprises accessing an accessible repository of available digital content pedigree data.

In accordance with an embodiment the repository of available digital content is stored within a digital memory, the digital memory forming part of a computer performing the at least one of cross-referencing and annotating.

In accordance with an embodiment the repository of available digital content is stored within a digital memory, the digital memory forming part of a computer located remotely from a computer performing the at least one of cross-referencing and annotating.

In accordance with an embodiment automatically at least one of cross-referencing and annotating with information from publicly comparable matching digital content comprises: providing within a digital content development environment an automated process for comparing the publicly comparable matching digital content and a commonly comparable matching digital content.

In accordance with an embodiment of the invention there is provided a method comprising: providing a server for storing a plurality of digital pedigree log records each comprising data relating to a different item of digital content; uploading first data relating to external digital content to the server by a requester; determining for the first data a result comprising an indication of a digital pedigree log record associated therewith; and, providing the result to at least one of the requester and the server.

In accordance with an embodiment the result is indicative of a uniqueness of the digital pedigree log record associated with the first data for determining an authenticity thereof.

In accordance with an embodiment the uploaded first data is data derived from digital content but from which the original digital content is not determinable.

In accordance with an embodiment of the invention there is provided a method comprising: providing a server for storing a plurality of digital pedigree log records each comprising data relating to a different item of digital content; and, automatically retrieving form each of a plurality of different memory locations, each accessible via a network, software code portions and for each software code portion: searching for same software code portion within the plurality of digital pedigree log records to determine a matched digital pedigree log record, when a matched digital pedigree log record is determined, annotating the matched digital pedigree log record with information relating to said memory location of the source code portion, and when other than a matched digital pedigree log record is determined, creating a new digital pedigree log record with information relating to said memory location of the source code portion and with data relating to the source code portion.

In accordance with an embodiment the different memory locations are memory locations within a digital content of a same digital content developer.

In accordance with an embodiment creating new digital pedigree log records includes storing information within the new digital pedigree log record relating to the same digital content developer.

In accordance with an embodiment the information comprises information relating to licensing of the software code portion.

In accordance with an embodiment the method comprises providing an indication of each matched pedigree log record having a source other than the same digital content developer to the same digital content developer.

In accordance with an embodiment the method comprises providing an indication of at least some matched pedigree log records to a source thereof.

In accordance with an embodiment of the invention there is provided a method comprising: providing a server for storing a plurality of digital pedigree log records each comprising data relating to a different item of digital content; storing within the server a first plurality of digital pedigree log records, each of the first plurality of digital pedigree log record relating to software code portions of a same digital content developer; automatically retrieving form each of a plurality of different memory locations, each accessible via a network and other than belonging to the digital content developer, data relating to software code portions and for each software code portion: searching for same software code portion based on the data relating to software code portions within the plurality of digital pedigree log records to determine a matched digital pedigree log record, when a matched digital pedigree log record is determined, providing an indication of the match to the digital content developer.

In accordance with an embodiment when a matched digital pedigree log is determined annotating the matched digital pedigree log record with information relating to a memory location of the source code portion.

In accordance with an embodiment of the invention there is provided a method comprising: (a) retrieving a first digital pedigree log record relating to an item of digital content and comprising at least one data element relating to the item of digital content, data elements being at least one of an invariant data element and variant data element; (b) the plurality of first digital pedigree log records to generate at least one of a second digital pedigree log record and a first digital pedigree log record signature; (c) storing the at least one of a second digital pedigree log record and a first digital pedigree log record signature on a computer with an association to the item of digital content; and (d) securely uploading the at least one of a second digital pedigree log record and a first digital pedigree log record signature to a commonly accessible secure server.

In accordance with an embodiment steps (a) to (d) are performed at least one of in dependence of a detecting a change to at least one first digital pedigree log record of the plurality of first digital pedigree log records and after a predetermined period of elapsed time.

In accordance with an embodiment combining according to a predetermined process the plurality of first digital pedigree log records to generate at least one of a second digital pedigree log record and a first digital pedigree log record signature comprises combining at least one of a predetermined portion of the invariant elements of the plurality of first digital pedigree log records according to a first aspect of the predetermined process, a predetermined portion of the variant elements of the plurality of first digital pedigree log records according to a second aspect of the predetermined process, and combining a first predetermined portion of the variant elements and a second predetermined portion of the invariants elements of the first digital pedigree log records according to a third aspect of the predetermined process.

In accordance with an embodiment of the invention there is provided a method comprising: providing first digital content of a digital content developer; inserting first content into the first digital content; determining whether the first content is internal digital content or is for being flagged as potential external digital content; and, when the first content is potential external digital content storing external to the first digital content data relating to a the insertion of the external digital content; and when the first content is internal digital content other than storing external to the first digital content data relating to a the insertion of the external digital content.

In accordance with an embodiment the first data is determined to comprise external digital content when the first data comprises pre-existing data.

In accordance with an embodiment the first data is determined to comprise internal digital content when the first data comprises newly developed content.

In accordance with an embodiment the newly developed content comprises manually entered data.

In accordance with an embodiment the manually entered data comprises text data provided via a keyboard.

In accordance with an embodiment of the invention there is provided a method comprising: automatically providing form each of a plurality of different memory locations, each accessible via a network, data relating to software code portions and for each software code portion: searching for same software code portion based on the data relating to software code portions within the plurality of digital pedigree log records to determine a matched digital pedigree log record, and when a matched digital pedigree log record is determined, providing an indication of the match to the digital content developer.

In accordance with another aspect of the invention there is provided a database comprising: a plurality of digital pedigree log records each associated with digital content and comprising: comparison data for use in comparing first digital content provided to determine whether a digital pedigree log record is associated with the first digital content; data relating to a pedigree of the digital content, the data indicative of a stated origin of the digital content; and, data relating to changes to the digital content subsequent to its purported origin.

In accordance with an embodiment the comparison data comprises a hash of the digital content.

In accordance with an embodiment the hash comprises a one-way irreversible hash.

In accordance with the invention there is provided a method comprising establishing a digital content development environment, the digital content development environment supporting the development of at least one digital content product of a plurality of digital content products. The method further comprising the steps of automatically detecting the introduction of at least one external content file of a plurality of external content files into the digital content development environment, and automatically logging at least one aspect of the at least one external content file.

In accordance with another embodiment of the invention there is provided a method of providing a digital pedigree log record associated with an digital content, the pedigree log record comprising at least a first predetermined portion and a second predetermined portion, the first predetermined portion comprised of at least an invariant information element of a plurality of invariant information elements relating to the digital content and the second predetermined portion variant information elements relating to the digital content, the variant information elements alterable at any time.

In accordance with another embodiment of the invention there is provided a method comprising providing at least a server of a plurality of servers, each server for storing at least one first digital pedigree log record of a plurality of first digital pedigree log records, each digital pedigree log record comprising at least one information element of a plurality of information elements relating to an digital content, each information element being at least one of an invariant information element, a variant information element, and a signature determined in dependence of the digital pedigree log record. The method further comprising the steps of uploading a second digital pedigree log record to the at least a server by a requester, requesting authenticity of the second digital pedigree log record, the authenticity determined in dependence upon a comparison of the second digital pedigree log record and the at least one first digital pedigree log record, and returning a result of the comparison for at least displaying the result of the comparison to the requester.

### BRIEF DESCRIPTION OF THE DRAWINGS

Embodiments of the invention will now be described in conjunction with the following drawings, in which:

FIG. 1A is a simplified bar graph showing known external content and unknown external content and a boundary therebetween;

FIG. 2A is a simplified diagram of a system providing publicly comparable content within a public signature repository;

FIG. 2B is a simplified bar graph showing publicly comparable content and publicly uncomparable external content and a boundary therebetween;

FIG. 3 is a simplified two dimensional bar graph showing content source assignment from gathering external content records, public comparison based annotation content, and best effort annotation content;

FIG. 4 is a simplified block diagram of an online system for the capture and storage of content pedigree;

FIG. 5 is a simplified block diagram of a portion of a pedigree capture and authentication system integrated within a computer system;

FIG. 6A is a simplified flow diagram of a method for tracking digital content development by means of a digital pedigree log record;

FIG. 6B is a simplified flow diagram of a method for creating a pedigree baseline file for existing digital content;

FIG. 7 is a simplified block diagram of a web searching approach to extracting and identifying digital content to provide a centralized digital signature repository;

FIG. 8A is a simplified flow diagram of a method of updating a digital pedigree log record of digital content in response to the addition of external content;

FIG. 8B is a simplified flow diagram of a method of updating a digital pedigree log record of digital content in response to identification of licenses / copyright in respect of external content;

FIG. 9A is a simplified data diagram of a digital pedigree log record format and digital pedigree log record signatures generated from it;

FIG. 9B is a simplified data flow diagram of generation and publishing of certified signature reports; and,

FIG. 10 is a digital pedigree log record format comprising invariant and variant elements.

### DETAILED DESCRIPTION OF EMBODIMENTS OF THE INVENTION

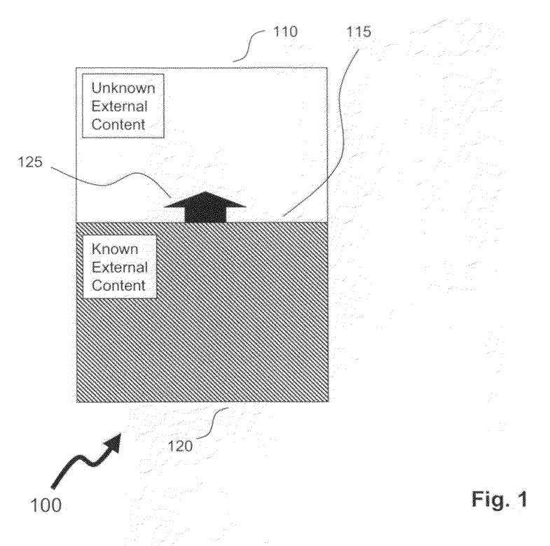

Referring to FIG. 1A, there is depicted a diagram of external content 100 comprising known external content 120 and unknown external content 110. The known external content 120 and unknown external content 110 are digital content used by a developer of digital content but developed by a different developer. Examples of external content include source code files, subroutines or partial source code files, images, audiovisual content, software libraries, text and hypertext. Optionally, the external content includes partial data buffers storing displayed code, code snippets, image snippets, and audiovisual clips.

The schematic 100 in representing known external content 120 and unknown external content 110 includes a boundary 115 therebetween. The external content 100 represents a portion of the digital content that the developer should establish proper ownership and licensure therefor. The arrow 125 represents a desire to improve identification of external content in order to reduce an amount of unknown external content and thereby reduce commercial risk to the developer. Within the prior art the typical process of moving arrow 125 higher and reducing the unknown external content 110 involves asking the software design team to gather a list of third party components and licenses, sending the list to lawyers, and then verifying ownership. Typically, such a list suffers from several flaws typically including some of the following:
Did the designers remember to include everything?
Did the designers deliberately not include something?
Entire packages (e.g. Apache Web Server, SQLite, Log4J) are easy to remember, but did the software design team report all sub-systems or code snippets from within these well-known packages or from other software?
Were 3rd party libraries and runtime systems included?
Were libraries included with the host operating system included?
Were redistributable libraries from the operating system or tool chain included?

Even where all of the above mentioned external content is reported, additional errors in the software design team reporting often occur as the actual external content whilst identified may actually have been sourced from another external source than the specific one used by the developer. In such instances the external content licensing and ownership is likely different to that indicated.

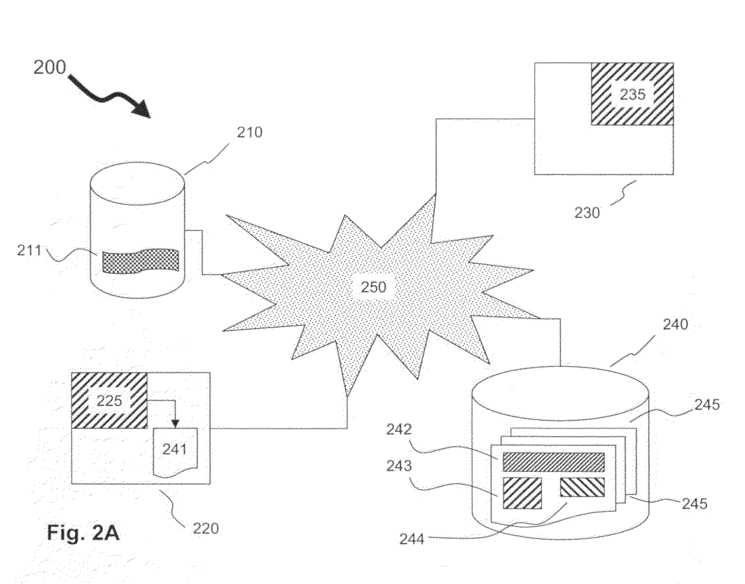

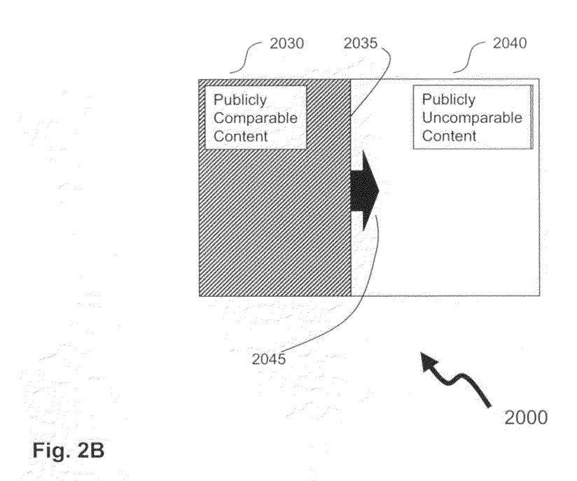

Referring to FIG. 2A, publicly comparable content 211 to address verifying and validating of external content is provided within development environment 200. Publicly comparable content 211 is digital content that is “comparable” without requiring the owner of the publicly comparable content to grant access to the comparison mechanism. The Linux kernel is an example of publicly comparable content 211 and is available for download from public servers 210. Developers compare both files and source code from within their digital content to the Linux kernel software without requiring the owners of Linux to grant permission or to provide private information about the content. As such, identifying external content that may originate from the Linux kernel is somewhat straightforward. Unfortunately, private content is much more difficult to compare without having access to the private source code and object code.

In order to provide publicly comparable private code without compromising the security of developers in respect to their code a one-way compact message digest of private content is generated and only a digital signature 241 is stored on a public server 240. Alternatively, a message digest is stored on the public server 240. As shown, in development environment 200 a first content development company 220 has a source code file 225 comprising proprietary subroutines. Accordingly, company 220 generates a digital signature 241 using a known signature process, for example Message-Digest algorithm 5 (MD5), Secure Hash Algorithm (SHA) such as SHAI, or through another process. The digital signature 241 is then stored on a known public server 240. Determinable from each digital signature 241 is the signature of the code 242, the name and contact information 243 of the copyright owner relating to the code, and licensing information 244.

At a later point in time second company 230 obtains a copy 235 of source code file 225, be it legally or otherwise. The second company 230 then digests the copy 235 and provides the digest to the public server 240 for comparison. When a match is reported, the second company 230 is informed that the first company 220 has a claim to file 235 via its original file 225. Additionally, the second company 230 also has the ability to contact the first company 220 via the name and contact information 243. Advantageously, when the licensing information 244 is stored within the data record, the second company also has foreknowledge of licensing terms for the source code.

Referring to FIG. 2B, external content 2000 comprises publicly comparable content 2030 and publicly uncomparable content 2040, there is shown a boundary 2035 between a portion of the digital content for which the developer has established proper ownership and licensure of intellectual property and the portion for which they have not. The trend arrow 2045 represents the desire to improve the identification of external content by public comparison in order to reduce the amount of unknown external content and thereby reduce commercial risk to the developer.

An association of ownership and licenses with external content within the developer's digital content decreases risks associates with externally developed digital content and intellectual property conflicts. This process is described hereinafter as annotation, described herein as comparison-based annotation and best-effort annotation, though other forms of annotation are also envisaged.

The second company 230 establishes an external content list from its development team that it believes is complete, With this list, the second company 230 undertakes a comparison-based annotation with publicly comparable content in two steps. First, for each element in the external content list, the second company 230 compares and cross-references the external content to a public repository of known external content to see if there is a match within predetermined limits. This is achieved by comparing either the digital content 235, a digest of the digital content, or a digital signature 241 of the digital content. Alternatively, this is achieved in another fashion. If there is a match, then the second company 230 annotates their content with the source—the first company 220—copyright ownership 243, and license 244 of the publicly comparable content that matched.

However, it would be beneficial for the second company 230 to search external content for all source code within its project and not just the source code identified within the external content list of its development team. The second company 230, therefore, compares all of its digital content to a public repository 240 of known external content 245 to see if there is a match within predetermined limits. There are many known methods to perform this comparison including brute force approaches where source code is compared starting with each line and so forth, processes wherein an analysis of source code is performed and compared to digest data, and other processes wherein hashing of source code data is used to identify potential matches which are then more closely compared. Of course, other methods of data comparison are also usable with the present embodiment. If there is a match, then this content is optionally annotated with source (the first company 220), copyright ownership 243, and license 244 of the publicly comparable content that matched.

A typical example of private source code file 225 is a source code file that is imported within a digital content, the source code file originating form one of the developers' previous places of employment. As such, the source code file 225 is the intellectual property of the previous employer. Alternatively, the source code file 225 stored within the computer systems of the first company 220 is open source software, code or digital content rather than proprietary source code. Optionally, this source code file 225 is publicly available code, software, or digital content that has been developed for the first company 220. Even moreso for a case where the source code file 225 is published, it is beneficial to identify and annotate that the source of the source code file 225 is the first company.

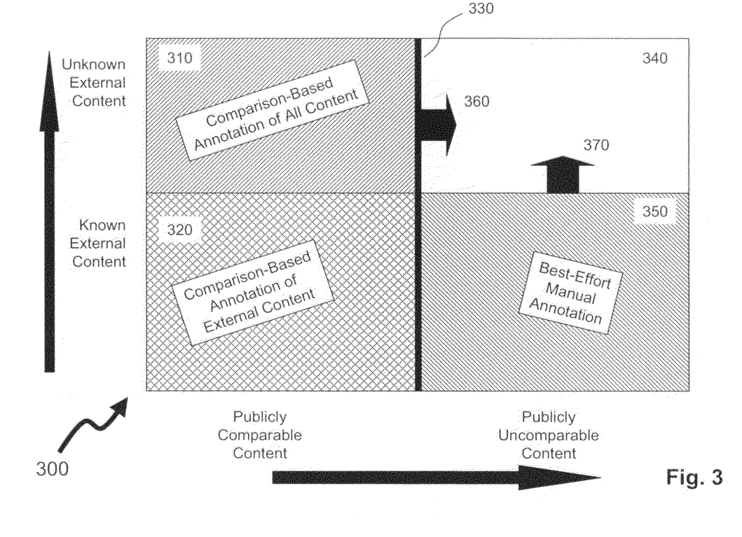

Referring to FIG. 3, the process presented hereinabove provides the second company 230 with a comparison-based annotation of external content 320 disclosed by its development team, and a comparison-based annotation of all content 310. As shown, boundary 330 does not sit to the extreme right of the external content 300 indicating that there is still external content that did not have a publicly comparable owner. To complete the process, best-effort annotation 350 is performed by the second company 230 on whatever content remains. In this best-effort annotation, for each element in the external content list that did not match to publicly comparable content, the second company 230 annotates the content, author, copyright ownership, and license to the best of its ability.

Of course, as the amount of publicly uncomparable content decreases, so does the manual effort of the second company 230. Further, as shown by the arrows 360 and 370 in the external content 300, as the amount of uncomparable content decreases so do risks of intellectual property liability.

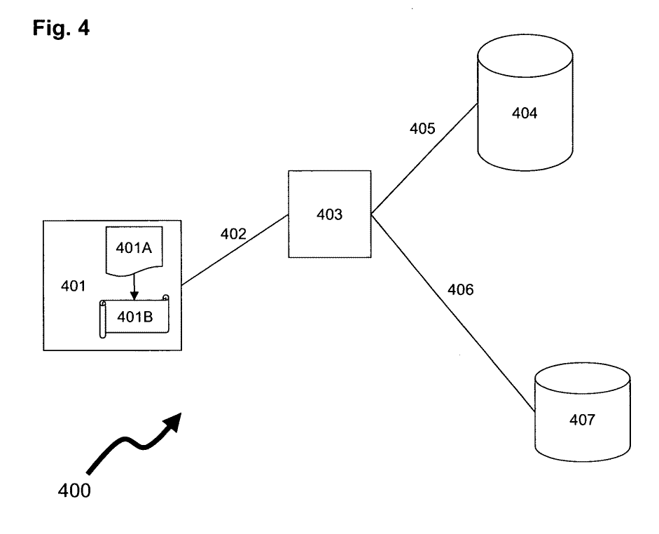

Human error is a common source of legal liability. Therefore, referring to FIGS. 4 through 6, described herein below is an automated process for tracking external content during development of digital content by a development team. Though the embodiments described refer to files and buffers, other data groupings are also effective in implementing the invention. It is advantageous to select a data grouping of sufficient size to be meaningful from an intellectual property licensing perspective.

Digital content is stored within one or more files. These include, but are not limited to, source code files, build script files, image files, audio files, video files, binary files, software libraries, text files, and hypertext files. Automating logging of creation, importing, linking, including, deleting, modification, moving, and renaming of all files used to build a system of digital content such as a software application or subsystem results in a more complete list of external content files. Any new file, which optionally is digital content over a specified predetermined size limit, is logged when appropriate as external content associated with the digital content.

Moving of digital content often relies on buffers. In some cases external content is imported into digital content files by cutting or copying and pasting, dragging-and-dropping, or by merging from other sources such as a web browser, a file browser, or from within a content-specific editor or viewer. Ultimately, each such cut-copy-and-paste, dragging-and-dropping or merging operation involves the transfer of a buffer of data from an external source into the digital content, which as noted above is logged. In this manner buffered data beyond a predetermined size that is introduced into the monitored digital content file is logged as external content associated with that file.

Policies are used to establish events and data for logging and capture thereof. For example, logging of external content is optionally restricted based on location. Location information refers to the location of either the external content or the digital content within a file system. The location within a file system of the content developer does not need generally to be logged since it is known to the content developer and easily discernable. However depending on policies location data is optionally logged. Further optionally, location data includes source location information to indicate a location from which the external content was retrieved.

Another policy relates to file types. Even in the file-system locations, folders or directories, that are monitored for events as indicated hereinabove, there are potentially some files of specific types that do not ultimately lead to the production of the digital content or product and therefore do not need to have their file-system events monitored. Examples include, but are not limited to, hidden files put in every project directory by source file version control systems such as Concurrent Versions System (CVS), or Subversion (SVN, initially released in 2000 by CollabNet Inc.). Alternatively, the automated external content monitoring and digital content tracking is performed with a configuration that does not ignore file-system events for these types of files.

Automatic logging of incoming external content greatly reduces the overall cost of logging each content package, file, and snippet that content developers bring into the system, while increasing confidence in completeness of the resulting log.

Referring to FIG. 4, a simplified block diagram shows an online system 400 for capturing and logging of content pedigree. A client tracker 401 captures the pedigree of a subject file 401A and logs same in a digital pedigree log record 401B that is generated automatically by the client tracker 401 upon detecting an event. Events include but are not limited to creation, importing, linking, including, deletion, modification, moving, and renaming together with the embedding of external content into the digital content. The digital pedigree log record 401B is an individual file. Alternatively, the digital pedigree log record 401B is a collection of files. Further alternatively, the digital pedigree log record 401B is a complex digital object. Further alternatively, the digital pedigree log record 401B is an individual data record. Further alternatively, the digital pedigree log record 401B is a collection of data records pertaining to the data of the subject file. The digital pedigree log record 401B is stored within a local database. Alternatively, the digital pedigree log record 401B is stored within a remote database.

The client tracker 401 communicates via a communication network with a digital pedigree log record signature server 404 and a subject signature server 407. For example, the communication network comprises the Internet. Alternatively, another communication network is employed. Further alternatively, communication is via a communication bus. In an embodiment, the communication network comprises a packet-oriented tracker connection 402, and the server connections 405 and 406 to the digital pedigree log record signature server 404 and subject signature server 407, respectively, coupled to a broadband network such as the Internet 403. Alternatively, the digital pedigree log record signature server 404 is local to the user. Further alternatively, the digital pedigree log record signature server forms part of the user's computer. Optionally the digital pedigree log record signature server 404 and subject signature server 407 are one server or co-located servers within a cluster. Alternatively, the digital pedigree log record signature server 404 is omitted.

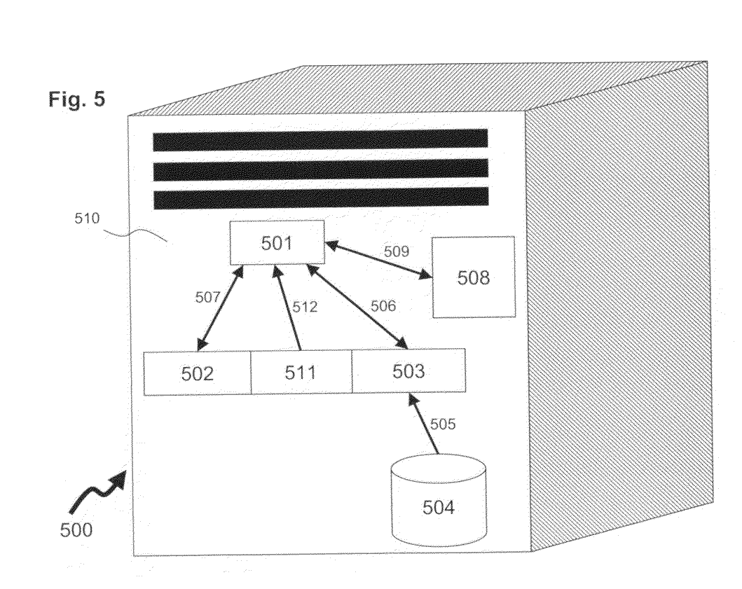

Referring to FIG. 5, a portion of the pedigree capture and authentication system integrated into a computer system 510 is shown. File alteration monitor 502 monitors activities within the computer system 510 and detects file alterations in the form of create, delete, and update. When a file alteration is detected, the file alteration monitor 502 sends a notification 507 to client tracker 501. The client tracker 501 then creates or appends a digital pedigree log record, such as digital pedigree log record 401B of FIG. 4. For example, this is performed relying on the operating system programming interface 206 to the operating system 503, and disk interface 505 and the storage medium 504 associated with the computer system 510. The client tracker 501 optionally communicates the file events to integrated content development environment 508 via the development environment interface 509 interfacing with a network in the form of an Ethernet network. Alternatively, the network is a broadband network. Further alternatively, the interface is internal to a single same system.

When external content is introduced into the computer system 510, a buffer monitor 511 automatically captures an external content event, for example using the file-system event, logs the external content event, and notifies the client tracker 501 via notification 512. Examples of the buffer monitor 511 include, but are not limited to, operating system utilities such as famd for Linux, FindFirstChangeNotification W for Windows, and utilities such as clipboards and corresponding monitoring agents. File system events are detected, for example, from changes to named directories and/or directory trees, for example by causing a resulting action when call handlers for those events are active. Additionally, modern editors, such as Eclipse (open-source software framework) or editors that plug into or interact with Eclipse are extensible to capture buffer paste events and call handlers.

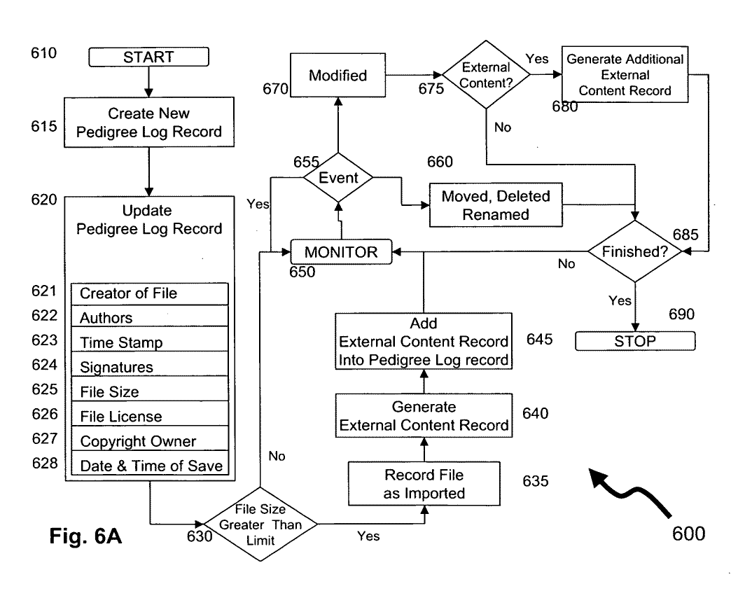

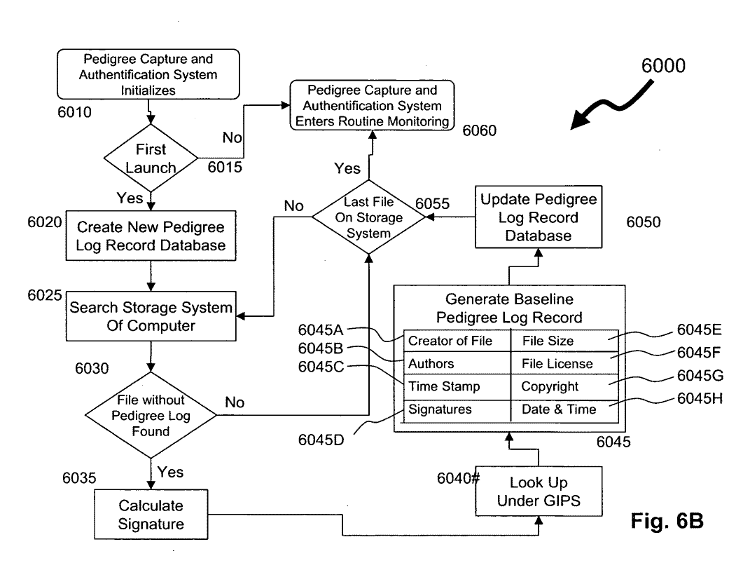

Referring to FIG. 6A shown is a flow diagram 600 for tracking digital content development with a digital pedigree log record, such as digital pedigree log record 401B of FIG. 4. At 600 a pedigree capture and authentication system operating within a computer system environment is provided. The pedigree capture and authentication system at 610 creates for each file in the content system, whether created or imported, a pedigree log record. At 620 a digital pedigree log record is populated with file records providing information on creator 621, authors 622, time stamp 623, signature 624, file size 625, file license 626, copyright owner 627, and date and time of the save of the subject file 628. At 630 the pedigree capture and authentication system determines whether at 610 the file was created with a file size beyond a known minimum size. The known minimum file size is optionally project, organization, application, and/or operating system dependent. When the known minimum file size is exceeded, the process moves to 635 where the file is recorded as imported, and to 640 where the pedigree capture and authentication system generates an external content record (ECR), which is stored in the pedigree log record at 645.

The pedigree capture and authentication system at 650 performs monitoring until an event is detected. When the known minimum file size was not exceeded, for example a blank source code file was opened, then the process continues at 650. Based upon monitoring for events at 650 and 655, the pedigree capture and authentication system determines whether an event, such as modification, deletion, renaming, and moving has occurred. Alternatively an event includes checking in or checking out of either digital content or a file. Alternatively another activity determined by the development organization as being an event to monitor and log is considered an event. While no event has occurred a monitoring loop continues. When, an event of deleting, moving, renaming is detected the process moves to 660 and updates the digital pedigree log record accordingly. The process continues at 685, determining whether the processes have completed. When completed the process stops at 690, otherwise the process returns to 650 and continues monitoring for digital content. Optionally, operations such as copying and renaming result in new or duplicate pedigree log records being created.

If the event detected is a modification then the digital pedigree log records are modified at 670. At 680 the process determines whether the modification relates to the inclusion of external content. External content comprises, but is not limited to, fully formed source code files, images, audio, video, software libraries, etc. External content optionally comprises partial buffers of data. Further, external content optionally comprises data subsets from other files, such as code snippets, image snippets, and video clips. If no external content was added then the process moves forward to 685 where a determination is made of whether to terminate the process or to return to monitoring at 650.

When the modification determined at 670 is external content as determined at 675, any external content brought into the development environment via a data or memory buffer is logged and an additional external content record (ECR) generated for each determined element of external content at 680. Once a content file is complete, the log file shows the pedigree of how the file was developed; along with external content records indicating suspected external content. Accordingly the pedigree capture and authentication system described with respect to FIG. 6 is automated thereby reducing many of the drawbacks of the prior art.

The flow diagram 600 shows a process for tracking digital content development using a digital pedigree logs record generated by a pedigree capture and authentication system wherein the digital content for which the digital pedigree log record is generated is new. However, the pedigree capture and authentication system is also applicable to systems that already contain digital content. Existing content will be referred to as legacy digital content or legacy code. Such legacy code is typically digital content comprising source code, object code, or audio-video data developed by a user or users. The digital content often includes content retrieved from external sources including commercial applications and code. Referring to FIG. 6B, shown is flow diagram 6000 wherein the pedigree capture and authentication system is loaded onto a computer system comprising legacy code. At 6010 the pedigree capture and authentication process is loaded and executed.

At 6015 the pedigree capture and authentication process checks whether this is a first launch of the process. Such a check for example comprising searching for a pedigree log record database stored on or in relation to the computer system. Alternatively the pedigree capture and authentication process searches predetermined local or remote locations to identify a pedigree log record storage relating to the process. If the pedigree capture and authentication process determines that this is not the first launch of the process for the computer system then at 6060 the process enters a routine monitoring mode similar to that shown in flow diagram 600 of FIG. 6A.

If the pedigree capture and authentication process determines that this is the first launch of the process then the process continues at 6020 creating a new pedigree log record storage. At 6025 the pedigree capture and authentication process searches the storage of the computer system upon which it is installed. For each located digital content file at 6030 a determination whether legacy content has been found that does not have associated pedigree logs. If legacy content is identified and having associated pedigree logs then the process continues at 6055 searching the system until the last file is evaluated and then at 6060 and enters routine monitoring mode. If legacy content is identified without associated pedigree log then at 6035 a digital content signature is calculated and at 6040 the digital content signature is searched as described herein below. A pedigree log record is generated at 6045 and at 6050 the pedigree log record database is updated. Then at 6055 to determine whether all files on the storage system have been checked. Accordingly the process determines and updates a pedigree log record database with the legacy content of the computer system or first storage system.

At 6040 the pedigree capture and authentication system then accesses a Global Intellectual Property System (GIPS). The GIPS provides for example various controlled and secure access methods to various users and administrators of an intellectual property tracking system. The GIPS provides search mechanisms for identifying external occurrences of digital content, including for example convergence search methods wherein the outcome of each stage of searching is an input for the next stage, thus narrowing the search domain as it progresses and providing bounds of a search domain should an exact match not be identified. Preferably, the searching process is fast and reliable. In this manner the pedigree capture and authentication system seeks to identify matching external content that matches the legacy code such that additional information is determinable relating to copyright, licenses, ownership, etc. where this information is not present within the legacy code or within files associated with the legacy content. For example, this information is retrievable form an external database.

At 6045 a baseline pedigree log record is generated for the digital content for which the digital content signature has been calculated and the GIPS accessed. As shown the baseline pedigree log record comprises entries creator of file 6045A, authors 6045B, time stamp 6045C, digital signature 6045D, file size 6045E, file license 6045F, copyright 6045G, and date and time stamps 6045H. Optionally, the baseline pedigree log record comprises additional information as outlined in respect of other embodiments presented within this description. Further optionally, the baseline pedigree log record comprises other information.

Upon generating the baseline pedigree log record at 6045 the pedigrees log record database is updated at 6050. Once a first storage medium is processed, a search of the system determines if other storage media require processing. When other storage media are located, the process continues searching for and processing files therein. Alternatively, for each storage medium a separate pedigree log record database is formed, for example to support storage medium portability. Further alternatively, portability is supported according to another solution. When all files have been checked and the process enters the routine monitoring mode at 6060.

The pedigree capture and authentication system is described hereinabove as checking to see whether a first launch of the application is occurring to trigger subsequent activities. This check is optionally automated, for example, by the application storing a datum once processes associated with a first launch are completed or alternatively another automated process based on system reboot, a time based trigger or forcing the adopter via a pointer to a repository to set a baseline before progressing. Alternatively, this process is initiated manually, for example by a systems administrator.

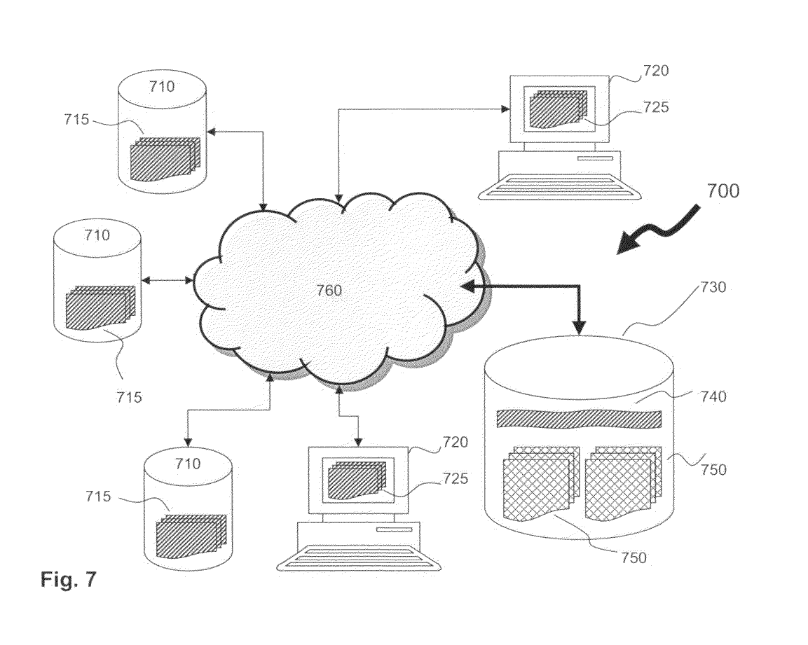

FIG. 7 is a simplified block diagram of a network for implementing an embodiment of the invention wherein a World Wide Web searching approach 700 for extracting and identifying digital content 715, 725 to provide a centralized digital signature repository 730 with digital content signatures 750 is supported. As shown connected to the Internet 760 is a centralized digital signature repository 730, upon which a web-crawler 740 is operating. The web-crawler 740 searches data within the servers 710 and computer systems 720 connected to the Internet 760 with the purpose of identifying external content. Any external content identified, such as first external content 715 on the servers 710, and second external content 725 on the computer systems 720 is used to generate digital content signatures 750 by the web-crawler 740 which then stores the signatures in the centralized digital signature repository 730. Optionally, the digital content is also analyzed with the web-crawler 740 to determine that it does not originate or include elements to which others have rights. The digital content signature 750 is optionally stored together with associated information and metadata for later retrieval and look up activities.

Accordingly, the web-crawler 740 crawls publicly accessible repositories of digital content such as servers 710 and computer systems 720, signs the software with robust signatures such as digital content signature 750, and stores them in the centralized digital signature repository 730 of publicly comparable content. Optionally, in addition to the digital content signature 750 additional information is stored in association therewith including, but not limited to data indicative of owner, author(s), license(s), copyright(s), etc. Employing publically accessible signatures presents a more straightforward way to compare code than comparing files stored in disparate locations. Over time, the centralized digital signature repository 730 of publicly comparable content is optionally improved by crawling of private repositories. Such a centralized digital signature repository 730 provides a benefit to its users in that they do not need to publicly disclose their digital content in order for said content to be publicly comparable. For instance company Z provides their digital content signatures stored on repository 730 for all their customers or the general public to compare and know they are using company Z's proprietary content without company Z disclosing the actual content to the public. This is accomplished for example by executing a crawler application locally within an Intranet of the company Z to form the digital content signatures and store same in repository 730.

The digital signature repository 730 is optionally expanded by linking the other steps in identifying external content as outlined supra to the web-crawler. For example, a developer within the second company 230 undertakes a best-effort manual annotation of the external content embedded into their digital content 235. If the best-effort manual annotation included a URL of the originating file or content, then optionally this information is provided to the web-crawler 740, the web-crawler 740 software then programmatically accesses the identified URL to verify the claim. If the URL is valid, then web-crawler 740 crawls that repository to the best of its ability and signs the digital content stored therein and stores the resulting digital content signatures 750 within the centralized digital signature repository 730. These signatures enable fast public comparison of publicly available software. Of course, the manually annotated digital content is storable with further automatic annotations relating to verification and or further comparison. Alternatively proactively uploading signatures of private content to centralized digital signature repository 730 is undertaken by enterprises.

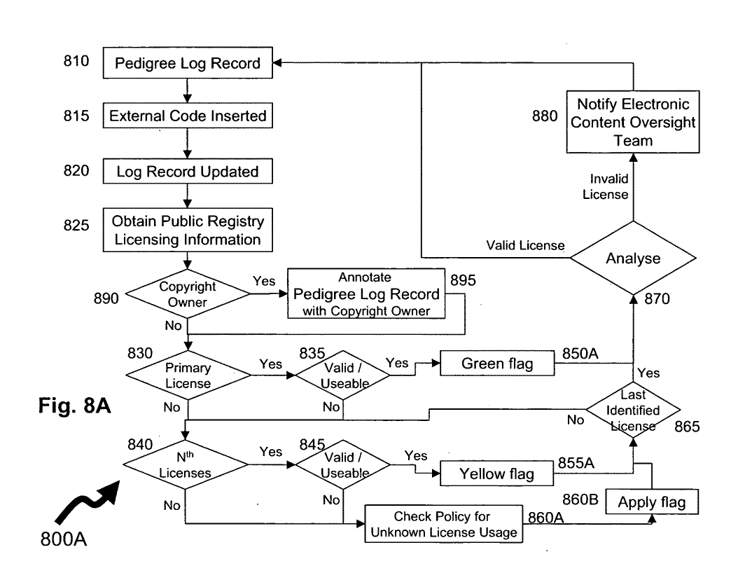

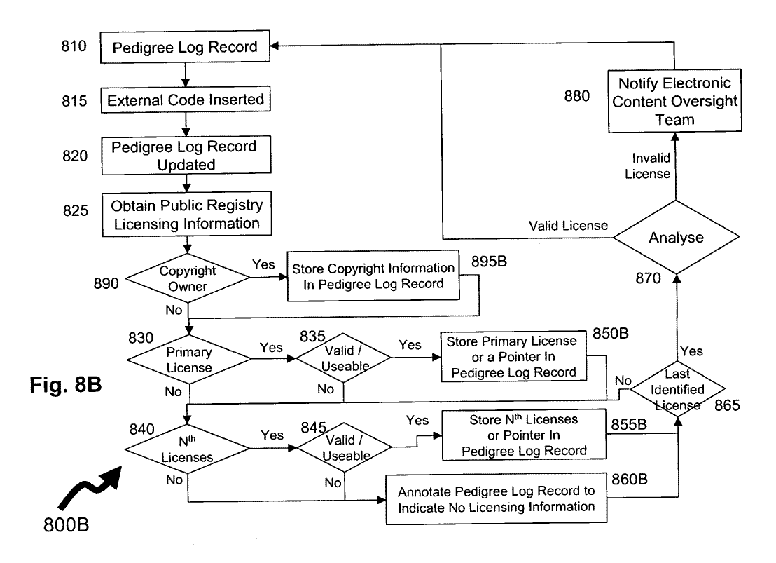

FIG. 8A depicts a flow diagram 800 for updating a digital pedigree log record of digital content in response to the addition of external content based upon capture and authentication system active upon a computer system. At 810 a digital pedigree log record is accessed in respect of a digital content being worked upon by a developer. The developer in step 815 has accessed external content and inserted it into the digital content they are developing, whereupon FindFirstChangeNotification W triggers due to the modification of the digital content, as they are operating within a Windows environment, and at step 820 the modification event is logged in the digital pedigree log record.

At 825 the capture and authentication system communicates to a centralized digital signature repository, such as centralized digital signature repository 730, and transmits a query comprising at least a digital signature of the external content inserted by the developer at 815. At 890 the centralized digital signature repository returns a first response in respect of copyright for the external content. If a copyright owner is known and indicated within the database then the process moves to 895A and adds the copyright information to the pedigree log record. Upon completing 895A or determining at 890 that no copyright information is known and indicated within the database, the process moves forward to 830. Alternatively, a pointer to the location of the pedigree information on the centralized digital signature repository 730 is recorded. Such a pointer implementation provides a mechanism for keeping the information current, centralized, and easily maintained since one copy of the pedigree information is stored as opposed to many copies which can easily become incorrect—out of date—within local storage. For example a particular external digital content file has a particular license when initially captured but at a subsequent date changes in aspects of the licensing information or more information becomes available on the license. With a pointer based approach to the digital pedigree log record, the latest information is made available given that the associated digital signature for it is stored within the on the centralized digital signature repository. Optionally, within each unique digital pedigree log is stored historical information relating to ownership, licensing, etc. and periods therefore. In such a manner, a developer can determine who owned and who owns external digital content for the present and for the past.

At 830 the centralized digital signature repository returns a response in respect to whether a primary standard license offering exists. If a primary standard license is offered the process moves to 835 and determines whether the primary standard license is acceptable in respect of the development organization and the digital content itself. If the primary standard license is acceptable then the process moves to 850A and the digital pedigree log record is annotated with a green flag associated with the external code inserted and the process moves forward to 870 and analyses the digital pedigree log record contents.

If the outcome of either the primary license-offering query at 830 or the determination of its acceptability at 835 is null then the process moves to 840 and attempts to identify N additional licenses. For each license n found, the process moves forward to 845 and determines whether the n^{th} license is acceptable in respect of the development organization and the digital content itself. For example, the n^{th} license may be one granting limited access, restricting customers to whom it solids applicable, or restricting functionality in conjunction with a lowered license fee, or an alternative licensing organization. Should the n^{th} license be acceptable then the process moves forward to 855A and the digital pedigree log record is annotated with a yellow flag associated with the external code inserted and the process moves forward to 865 and determines whether this is the last identified license analyzed or found. If no other licenses are identifiable then the process moves forward to 870 and analyses the digital pedigree log record contents. If another license is determined as available at 865 then the process returns to 840.

If the outcome of either the n^{th} license query at 840 or the determination of its acceptability at 845 is null then the process moves to 860A and the license is checked against existing policy of the development organization. At 865B digital pedigree log record is annotated with a flag associated with the external code that is determined in dependence upon the check of the n^{th} license against the existing policy, and the process continues at 865 and a determination of whether additional licenses exist for analysis. Based upon this determination the process moves to either 840 or 870. At 870 the process analyses the digital pedigree log record contents wherein a valid license results in the process returning to 810 and awaiting another event in relation to the digital content. A decision at 870 that no valid license exists results in the process continuing at 880 and a notification being issued to an oversight team for the digital content development. Upon issuing the notification, the process moves to 810 and awaits a further modification event to the digital content. The determination of no valid license existing is based upon a policy or policies active within a development environment and may include raising of a violation flag based on the policy/policies. For example none of the identified licenses are acceptable through the policy or the lack of identified license information for digital content is a prohibited outcome by the policy.

Notification to an oversight team allows the developer to identify a potential issue very quickly and take action accordingly. Such action may be for instance the decision to remove said external content from the development digital content to avoid an intellectual property issue. Alternatively, the action comprises reviewing the primary/N licenses to determine an acceptable route forward for the development of the digital content. Alternatively, rather than recording information within the digital pedigree log record a pointer to the location of this information within the centralized digital signature repository 730 is recorded. Such a pointer implementation provides a mechanism for maintaining information current and centralized. For example a primary or n^{th} license for a particular external digital content file may have the correct licensing requirements when initially captured but may at a subsequent date change in respect of aspects of the license or more information may become available on the license; by centralizing the information, a need to constantly monitor and update is obviated. With a pointer based approach to the digital pedigree log record then the latest information is available given that the associated digital signature for it is stored within the on the centralized digital signature repository. Optionally, within the centralized database is also stored historical data relating to licenses and licensing.

Referring to FIG. 8B a flow diagram 850 for updating a digital pedigree log record of digital content in response to the identification of copyright and licensing information in respect of external content based upon capture and authentication system active upon a computer system is shown. The initial flow is similar to the process flow 800 described hereinabove until the process reaches 890 and the centralized digital signature repository returns a first response in respect of copyright for the external content. If a copyright owner is known then the process moves to 895B and the copyright information is stored within the pedigree log record. Upon completing 895B or determining at 890 that no copyright information is known, the process moves to 830

At 830 the centralized digital signature repository returns a response relating to whether a primary license offering exists. If a primary license offering exists the process moves to 835 and determines whether the primary license is acceptable in respect of the development organization and the digital content itself. If the primary license is acceptable then the process continues at 850B and the digital pedigree log record is updated by storing the primary license information associated with the external code inserted and then continues at 840.

If the outcome of either the primary license query at 830 or the determination of its acceptability at 835 is null then the process moves to 840 and attempts to identify N licenses. If an n^{th} license is found then the process continues at 845 and determines whether the n^{th} license is acceptable in respect of the development organization and the digital content itself. Should an n^{th} license be accepted then the process at 855B updates the digital pedigree log record is by storing all information associated with the external code inserted and at 865: determines whether all licenses have been found. If it is determined that all licenses have been found, at 870 the digital pedigree log record contents are analyzed.

If the outcome of either the secondary license query at 840 or the determination of its acceptability at 845 is null then at 860B the digital pedigree log record is annotated with the information that no licenses associated with the external code were identified and at 865 a determination of whether this was the last license identified for assessment is made. If an additional n^{th} license exists or potentially exists then the process returns to 840, and if no additional licenses exist the process continues at 870 and analyses the digital pedigree log record contents as outlined supra in respect of FIG. 8A. Alternatively, rather than recording information within the digital pedigree log record a pointer to the location of this information on the centralized digital signature repository 730 is recorded. As noted supra such a pointer approach provides a mechanism for keeping the information current and centralized.

The flow diagrams 800 and 850 of FIGS. 8A and 8B include an accounting for identification of N licenses but consider only a single copyright being identified. It would be evident that alternatively this same multiplicity is applied to copyright ownership. Hence, optionally the processes of flow diagrams 800 and 850 are modified to include the identification and application of multiple copyright owners to a single item of digital content. Optionally, the processes treats licenses, copyright, authorship or similar meta-data or information much the same as described here for license information. Further each identification and storage of identified information includes gathering, storage and subsequent conveying of a source of information as well as particulars of each piece of information, which includes how the particular file's related meta-data or information was verified, for instance, how it was determined that a particular file is governed by a GPL license or belongs to ACME corporation.

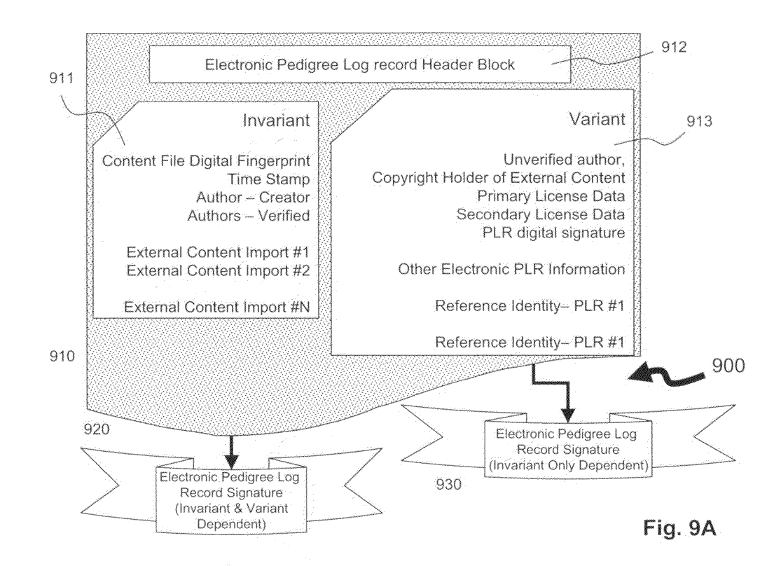

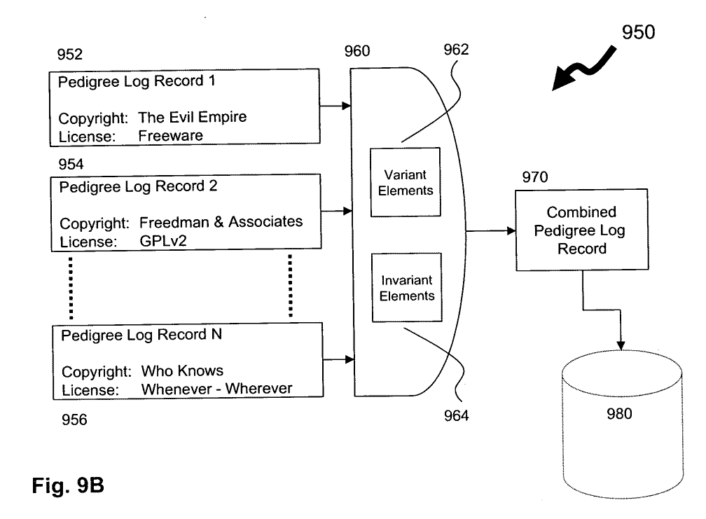

FIG. 9A illustrates an embodiment of the invention by a digital pedigree log record format 910 and digital pedigree log record signatures 920, 930 generated from a system according to an embodiment of the invention by a pedigree log record process 900. The digital pedigree log record format 910 comprises a header block 912, for example containing a reference to the digital content identity, an original date and time of creation, and an identity of the developer such as organization name, division, team and project reference.

The digital pedigree log record format 910 optionally comprises two data arrays, an invariant array 911 that comprises invariant information elements and variant array 912 that comprises variant information elements. Invariant information elements are those that do not change with the evolution of the digital content such as editing, merging, copying, and even deleting the digital content. Examples of such invariant information elements include, but are not limited to, a digital signature of the digital content, a time signature when the digital pedigree log record was created, an identity of an author creating the digital pedigree log record, an identity of an author creating the digital content; a verified author, and aspects of external content imported into the digital content.

Variant information elements are those that adjust with the different operations of copying, editing, deleting, merging in respect of the digital content and external content. Examples of variant information elements include, but are not limited to, an unverified author, an identity of a copyright holder of external content, an aspect of a primary license associated with external content, an aspect of a license relating to external content and other than the primary license, and an aspect of another digital pedigree log record, and a reference identity of another digital pedigree log record

An embodiment of a pedigree log record is shown at 900 and provides for two digital pedigree log record signatures to be generated. The first digital pedigree log record signature 920 is generated using both the invariant array 911 and variant array 912 according to a signature generating process. The second digital pedigree log record signature 930 is generated according to the same process but comprises only invariant array 911. Alternatively, digital pedigree log record signatures are generated using predetermined portions of each of the invariant array 911 and variant array 912, or only the variant array 912.

Now referring to FIG. 9B shown is an embodiment of the invention relating to the generation and publishing of certified signature reports 970 to a centralized digital signature repository 980. As shown in certified report generation flow 950 multiple distinct and non-empty pedigree log records 952, 954 and 956 are combined in combining process 960. As shown first non-empty pedigree log record 1 952 has copyright owner “The Evil Empire” and an associated license “Freeware”, second non-empty pedigree log record 2 954 has a copyright owner “Freedman and Associates” and a license under “GPLv2”, GNU General Public License Version 2. Also shown is third non-empty pedigree log record 956 with copyright owner “Who Knows” and a license “Whenever—Whatever”. Each of these non-empty distinct pedigree log records 952, 954, and 956 is fed to transformer process 960 that transforms the aggregated information for both the invariant elements 964 and variant elements 962 and generates a combined signature 970 out of these combined invariant elements 964 and combined variant elements 962. The resulting combined signature 970 is then uploaded to centralize digital signature repository 980 for authentication purposes.

The method of certified report generation flow 950 allows a digital content producer to establish that at the time of the generation of the combined signature 970, the information in the report relating to the non-empty distinct pedigree log records 952, 954, and 956 was what they knew. In this manner if the digital content provider generates the combined signature 970 today with second pedigree log record 954 under license “GPLv2” then this will be reflected in the combined signature 970 on the centralized digital signature repository 980. If in the future the second pedigree log record 954 is modified to reflect that whilst the copyright holder “Freedman and Associates” is maintained that the license is now “GPLv3” then the certified report generation flow 950 when executed results in a new combined signature 970 being generated with a new date and uploaded to the centralized digital signature repository 980. Accordingly, the digital content provider is able to maintain a certified audit trail of what they knew at each instant of generating a combined signature 970, and hence present such information during licensing discussions, legal activities etc.

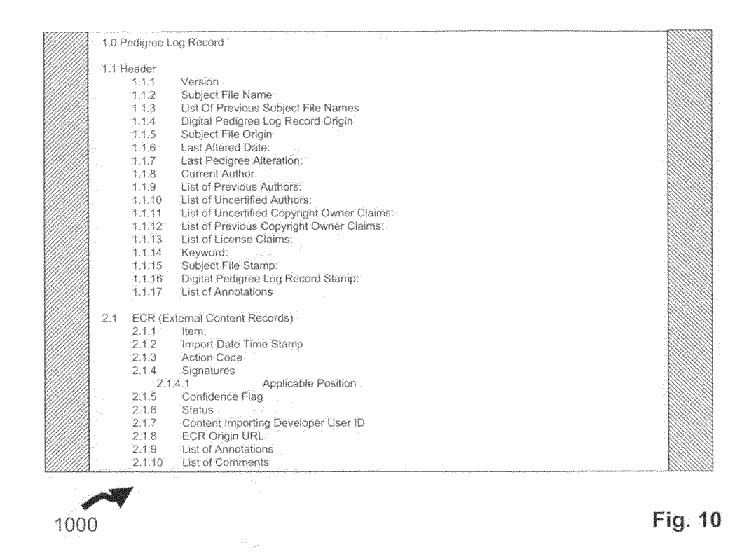

Now referring to FIG. 10 another embodiment of a second digital pedigree log record format 1000 is shown. Unlike first digital pedigree log record format 910 this embodiment has both invariant elements and variant elements included within a single file format. As shown second digital pedigree log record format 1000 comprises the following elements:

### 1.0 Digital Pedigree Log Record

### 1.1 Header

1.1.1 Version: shows the version of the digital pedigree log record schema;

1.1.2 Subject File Name: Shows the current name of the subject file. The name is optionally stored as full qualified URL which in turn locates the file within the system or the repository system uniquely;

1.1.3 List of Previous Subject File Names: list of all previous file names used by subject file and the corresponding dates if any;

1.1.4 Digital pedigree log record Origin: Shows the origin of this digital pedigree log record i.e. imported or created. In each case it optionally comprises further information such as creator application name or the location where it was imported from e.g. GIPS, external, workspace;

1.1.5 Subject File Origin: This is the name of the utility through which the subject file was generated. For new files in Eclipse, for example, it is “eclipse”. For C object files generated by a C compiler, for example it is “gcc”. For Java archives generated by running the Java archiver, for example it is “jar”. Over time, various code generators, preprocessors and translators can provide names for automatically generated files. Of course, other labels or identifiers are usable for identifying the above origins, though it is preferred that a single same standard identifier is used for a single same origin;

1.1.6 Last Altered Date: The date the subject file has been altered last;

1.1.7 Last Pedigree Alteration: The date and time of the last pedigree alteration, such as when new authors are added, or when external content is brought in;

1.1.8 Current Author: Author of the last changes on the file, or if the file was imported and not edited, then there is no author and, for example, “No Author” is used;

1.1.9 List of Previous Authors: A list of other certified authors along with a time signature of their last modification, such as for example Protecode registered authors;

1.1.10 List of Uncertified Authors: A list of authors not certified but believed to be authors, such as for example those not registered by a systems administrator;

1.1.11 List of Copyright Owner Claims: Name of organization or author, which claims to currently own the copyright of the file. This list typically has a single element in it, for example the author or the copyright owner designated by the project to which the author is contributing.;

1.1.12 List of Previous Copyright Owner Claims: Names of the organizations or authors that previously owned the copyright to this file. This field is for example automatically annotated by server lookups;

1.1.13 List of License Claims: Name of license. This list typically has one element in it but could have many as a result of versioning, or multi-licensed products. The license is assumed to be Proprietary unless it has been provisioned to something else in the user preferences or by the project administrator. For derivative works, this license claim may be superseded by the license terms of the work from which this one was derived;

1.1.14 Keyword: Typically a list of key words associated automatically or manually to the subject file;

1.1.15 Subject File Signature: latest signature of the subject file;

1.1.16 Pedigree log record Signature: latest signature of the pedigree logs record. Optionally this is considered to calculate the signature of the file for circular dependence reasons, i.e. a signature is calculatable over the rest of the file. This is to be used for integrity checking of the pedigree log record at opening time. Any manual editing of the file will invalidate the signature and result in corrupted pedigree log record; and

1.1.17 List of Annotations: For example manual best effort annotation information provided by users at file level;

1.1.18 List of Comments: For example, any comments associated with file, developer notes, etc.

A sample ECR (External Content Records(s)) content is set out below (numbered lines).

2.1.1 Item: Typically contains one instance of external content recode;

2.1.2 Import Date Time Stamp: Date and time stamp for the import event;

2.1.3 Action Code: A code indicative of, for example, whether a full file import or partial code import occurred;

2.1.4 Signatures: indicative of an origin of the ECR, for example a subject and pedigree log record of originating external content;

2.1.4.1 Applicable position in the subject file,

2.1.5 Confidence Flag: A flag, for example none, low, medium, or high. None is associated, for example, when a source is still unknown, low confidence for a site of unknown programs, medium is associated, for example, for a well-known site without documented intellectual property audit processes, and high is associated with a site having documented intellectual property audit processes. Examples of high confidence sites including for example Eclipse, kernel.org, and Apache;

2.1.6 Status: An indication, for example not looked up yet, not found, cross-referenced, annotated, and authenticated. This is optional in embodiments employing pointers within the digital pedigree log record;

2.1.7 Content Importing Developer User ID: For example a unique Protecode User ID of the developer that imported the external content;

2.1.8 ECR Origin URL: An indication, for example the originals source location and the means of importing, such as download, cut-and-paste, text copy etc. This is optional in embodiments employing pointer within the digital pedigree log record;

2.1.9 List of Annotations: For example, manual best effort annotation information provided by users.

2.1.10 List of Comments: For example, any comments associated with ECR, developer notes, etc.

In the embodiments presented hereinabove the annotation of digital pedigree log records is presented as an event occurring at a single point in time as external content is authored into the digital content. Alternatively, the annotation of digital pedigree log records is repeated at intervals, for example based upon a manual event. Alternatively, the intervals are based on an automated event. For example, repeating one of the processes relating to the generation of a digital signature from a digital pedigree log record results in the files being re-annotated. Accordingly in the examples presented re-annotating one digital pedigree log record, for example to reflect a change in licensing from GLPv2 to GLPv3 for “Freedman and Associates” in second non-empty pedigree log record 2 954, would be incorporated the next time a report event was performed for the digital content. Optionally the variation of the licensing is externally communicated on an automatic basis to other digital content producers who have registered digital signatures containing the signature of second non-empty pedigree log record 2 954.

Whilst the embodiments described hereinabove emphasize tracking of incorporation of external content into digital content it would be understood by one skilled in the art that such digital pedigree log records and digital pedigree log record signatures are exploitable by a developer to provide clear ownership and title to their own digital content by registering and supplying such information to a centralized digital signature repository.

Within the embodiments presented hereinabove emphasis has been placed upon identification and extraction of information in respect of digital content and creating the digital pedigree record log file, for example by automated processes in execution upon the user's computer system, local systems or remote systems and operating in conjunction with other systems. However, in many instances where information cannot be identified externally or as a first step prior to searching for identical external content, it is desirable to provide information within the digital pedigree log record that is annotated by a development engineer or development team based upon their best knowledge.

It is sometimes desirable to restrict distribution of annotations with digital signature or digital pedigree log record as the annotations are made on a best effort basis of the development team. Such restrictions are optionally implementable at the local, remote, and global levels of release of information pertaining to the digital content file as determined by a policy of the developer of the digital content.

According to the embodiments presented hereinabove modifications to digital content across a wide variety of clients operating simultaneously may represent significant overhead to a server. Therefore it is sometimes beneficial to include caching of the digital pedigree log record, digital signature and other aspects of the electronic data to reduce a load upon the server. Such caching is optionally performed at the user's computer, local to the user, or remote according to different factors, such as the demands of the overall system and the preferences of the development organization.

The term external digital content is used throughout the application and claims that follow to refer to digital content that is for being identified. In an embodiment, the external digital content is all digital content that is other than generated through a typical content development methodology, for example through typing. This includes all imported, pasted, and copied material. In another embodiment, digital content lacking pedigree information and inserted within digital content other than via a user's keyboard or other input device is labeled as external digital content and content having a pedigree indicative of it being external digital content is also external digital content. In yet another embodiment, digital content is analyzed during entry thereof to determine whether or not it is external digital content.

The term digital content as used herein comprises and not intended to be limited by the following: digital source code, digital object files, digital images, digital music files, digital video content, digital animation content, digital header files, digital libraries, and digital text files.

Numerous other embodiments may be envisaged without departing from the spirit or scope of the invention.

What is claimed is:

1. A method comprising:
providing first digital content of a digital content developer;
retrieving from a system external to systems of the digital content developer external digital content of a party other than the digital content developer;
inserting the external digital content within the first digital content;
automatically detecting introduction of the external digital content into the first digital content; and,
storing external to the first digital content, data relating to a source of the external digital content.

2. A method according to claim 1 wherein the data relating to a source of the first digital content comprises data relating to licensing of the external digital content.

3. A method according to claim 2 wherein the data relating to a source of the first digital content comprises pointer data indicative of a location external to systems of the digital content developer having data stored therein data relating to licensing of the external digital content.

4. A method according to claim 3 wherein the pointer data comprises an indication of a record within a digital signature database comprising data relating to licensing and comparable content.

5. A method according to claim 4 wherein the comparable content comprises digitally signed digital content.

6. A method according to claim 4 wherein the record comprises an unalterable portion and an alterable portion, the unalterable portion comprising data relating to the digital content and the alterable portion comprising data relating to licensing thereof.

7. A method according to claim 6 wherein the data relating to licensing thereof comprises an indication of at least an owner of intellectual property within the digital content.

8. A method according to claim 6 wherein the data relating to the digital content comprises a digital signature of at least a portion of the digital content.

9. A method according to claim 8 wherein the data relating to the digital content further comprises at least one of the following: a name of a license owner, a digital signature signed by the license owner, a name of an author of the digital content, a source of the digital content, and terms for a license of the digital content.

10. A method according to claim 1 comprising applying at least a policy to the inserted digital content to one of allow its insertion and prevent its insertion based on the at least a policy relating to licensing of external digital content.

11. A method comprising:
providing first digital content of a digital content developer;
inserting first content into the first digital content;
determining whether the first content is internal digital content or is for being flagged as potential external digital content;
when the first content is potential external digital content storing external to the first digital content data relating to a the insertion of the external digital content; and
when the first content is internal digital content other than storing external to the first digital content data relating to a the insertion of the external digital content.

12. A method according to claim 11 wherein the first data is determined to comprise external digital content when the first data comprises pre-existing data.

13. A method according to claim 11 wherein the first data is determined to comprise internal digital content when the first data comprises newly developed content.

14. A method according to claim 13 wherein the newly developed content comprises manually entered data.

15. A method according to claim 14 wherein the manually entered data comprises text data provided via a keyboard.

16. A method according to claim 11 wherein the data relating to a the insertion of the external digital content comprises data relating to a form of entry of the external digital content into the digital content.

17. A system comprising:
a processor, a memory and user input device for in combination
having first digital content of a digital content developer stored therein,
for supporting insertion of first content into the first digital content,
for determining whether the first content is internal digital content or is for being flagged as potential external digital content;
when the first content is potential external digital content for storing external to the first digital content data relating to a the insertion of the external digital content; and
when the first content is internal digital content for other than storing external to the first digital content data relating to a the insertion of the external digital content.

18. A system according to claim 17 wherein the system supports manual data entry via a keyboard and automatic data entry via importing of data and pasting of data and wherein first content is potential external content when provided via automatic data entry.
